(19) United States
(12) Patent Application Publication
(10) Pub. No.: US 2012/0193487 A1
(43) Pub. Date: Aug. 2, 2012

(54) ADJUSTABLE VACUUM SUCTION BOTTLE SUPPORT RACK

(76) Inventor: YU-YAO TSAO, New Taipei City (TW)

(21) Appl. No.: 13/014,726

(22) Filed: Jan. 27, 2011

(51) Int. Cl. F16M 11/04; B60B 33/00

(52) U.S. Cl. 248/125.1; 248/121; 248/122.1; 16/18 R

(57) ABSTRACT

An adjustable vacuum suction bottle support rack includes a stand, which forms at least one engagement slot; at least one suspension bracket, which has an end forming a mounting block receivingly engageable with the engagement slot of the stand; an anti-sliding seat, which is arranged on the stand for fixing the suspension bracket; and a leg, which has an end forming a coupling block receiving engageable with the engagement slot of the stand. The arrangement of the present invention allows for easy assembling and disassembling of the vacuum suction bottle support rack, reducing the amount of space occupied, and realizing stable support and retention of a storage bottle through an adjustment section of the suspension bracket to thereby improve the stability and preventing undesired oscillation.

### (a) TECHNICAL FIELD OF THE INVENTION

The present invention generally relates to a structure of vacuum suction bottle support rack, and more particularly to an adjustable vacuum suction bottle support rack that can be easily assembled and disassembled.

### (b) DESCRIPTION OF THE PRIOR ART

The advent of technology era brings development of human society and progress in every respect. Medical resources, which have been of great lack in the early days of human society, were quickly developed at least in respect of medical system and facility.

For example, in an operation room, a vacuum suction drainage system is commonly used in almost all types of surgical operations for suction and drainage of waste liquids, bloods, and medication during the operations. Conventionally, a vacuum suction device is supported on a fixed rack, which comprises a suspension bracket that is coupled to a stand by means of secured fixation or welding and only works for suspending or hanging four storage bottles. Further, the conventional vacuum suction device is bulky in size. The support racks that support vacuum suction systems are often used in multiplicity in a single operation or frequent replacement of the vacuum suction system is needed, making the use of the conventional vacuum suction system extremely inconvenient. Also, the bulky size of the conventional vacuum suction devices occupies a large amount of the precious space in an operation room.

In view of these problems, the present invention aims to provide a solution that overcomes such problems.

### SUMMARY OF THE INVENTION

An objective of the present invention is to provide an adjustable vacuum suction bottle support rack, which adopts a combined arrangement of a mounting block of a suspension bracket and an engagement slot of a stand to facilitate easy assembling and disassembling of the suspension bracket.

To achieve the above objective, the present invention provides an adjustable vacuum suction bottle support rack, comprising a stand, which forms at least one engagement slot; at least one suspension bracket, which has an end forming a mounting block receivingly engageable with the engagement slot of the stand; an anti-sliding seat, which is arranged on the stand for fixing the suspension bracket; and a leg, which has an end forming a coupling block receiving engageable with the engagement slot of the stand.

According to the technical solution adopted in the present invention, an arrangement of mounting block of suspension bracket is provided for easy assembling and disassembling of the vacuum suction bottle support rack thereby reducing the amount of space occupied and increasing the number of storage bottles that can be suspended. With a carrying frame and adjustment section formed on the suspension bracket, the storage bottle can be supported and held thereby improving the stability and preventing undesired oscillation. Further, the carrying frame can be adjusted according to the size of the storage bottle suspended to move forward or rearward in order to stably support and hold the storage bottle.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is an exploded view of an adjustable vacuum suction bottle support rack according to the present invention.

FIG. 2 is a perspective view of the adjustable vacuum suction bottle support rack according to the present invention.

FIG. 3 is an exploded view of a suspension bracket of the vacuum suction bottle support rack according to the present invention.

FIG. 4 is a schematic view illustrating the mounting of the suspension bracket.

FIG. 5 is a perspective view illustrating the mounting of a storage bottle on a suspension bracket according to the present invention.

FIG. 6 is a perspective view illustrating the engagement and fixing of the leg according to the present invention.

FIG. 7 is an enlarged view of a portion of the present invention.

FIG. 8 is a perspective view illustrating an application of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

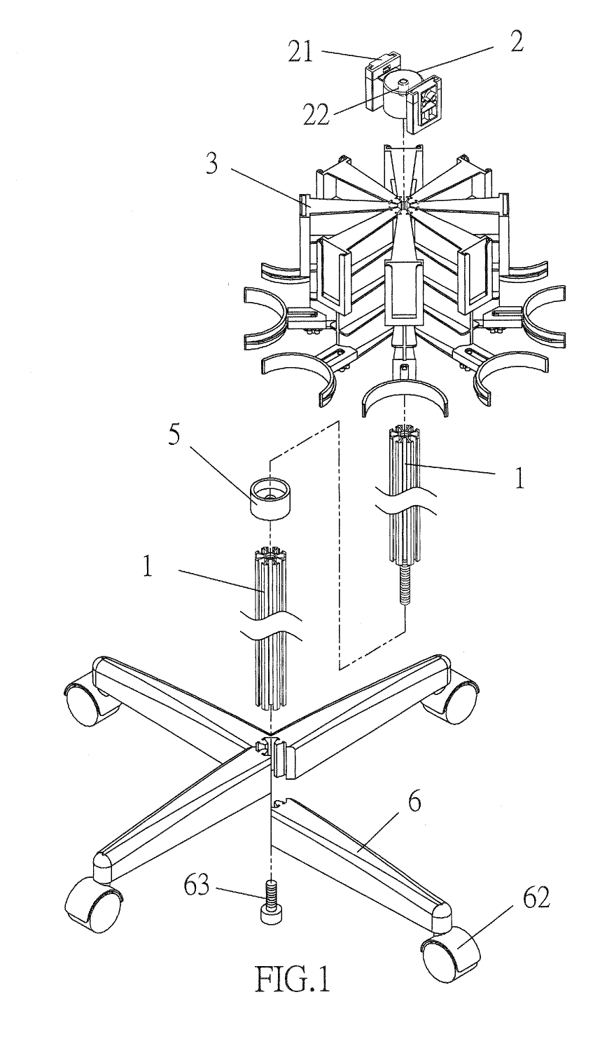

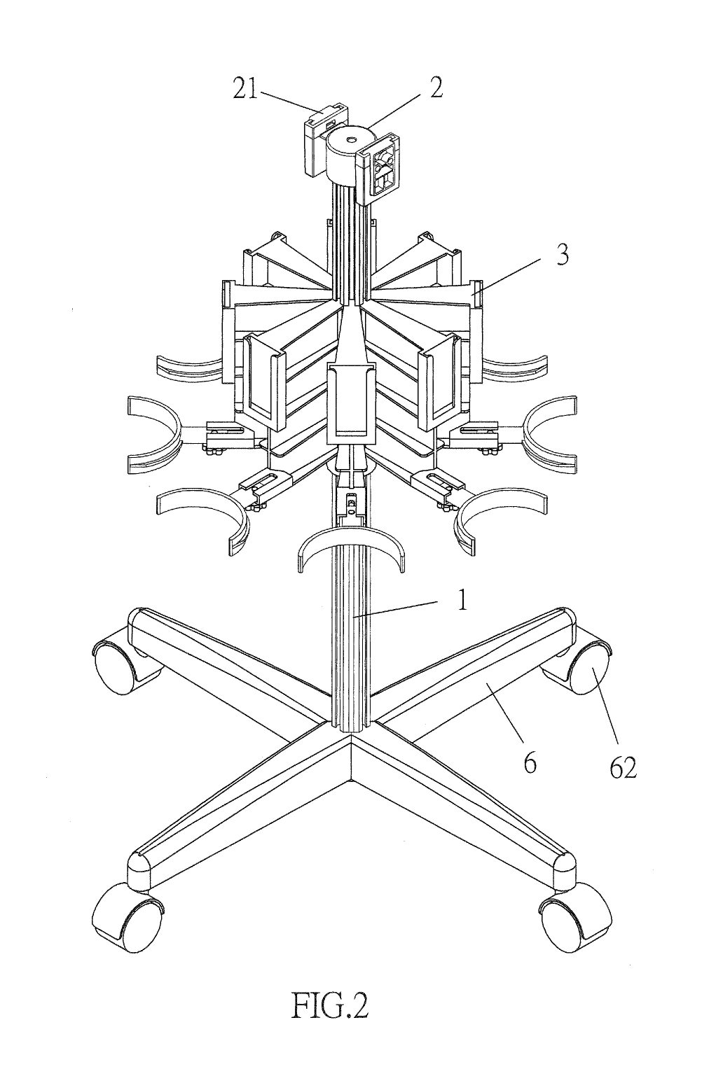

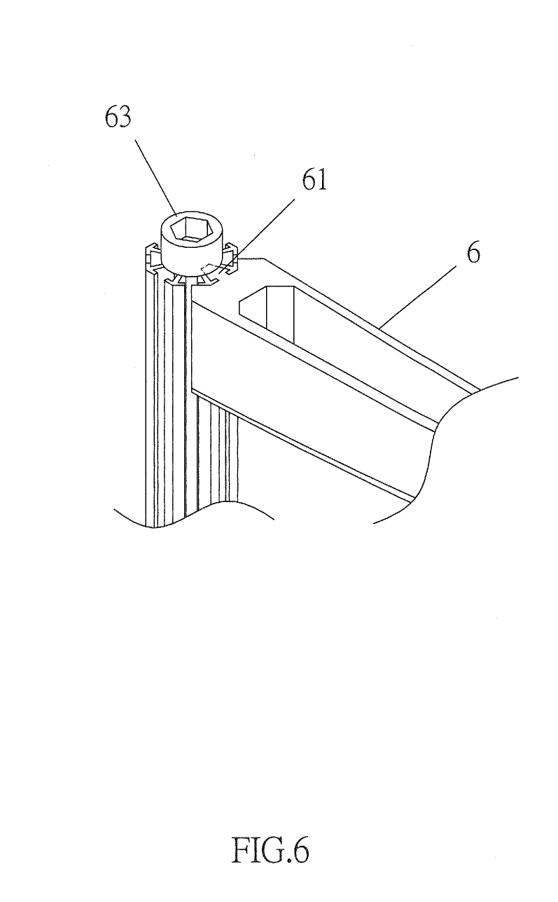

Referring to FIGS. 1, 2, 3, and 4, which are respectively an exploded view and a perspective view of an adjustable vacuum suction bottle support rack according to the present invention, an exploded view of a suspension bracket of the vacuum suction bottle support rack according to the present invention, and a schematic view illustrating the mounting of the suspension bracket, the drawings show that the present invention comprises a stand 1, which forms at least one engagement slot. The stand 1 has a top end to which a top cap 2 is mounted. The top cap 2 comprises an internally-arranged fastener element 22 to securely fix to the stand 1. At least one suspension bracket 3 is provided, which has an end forming a mounting block 4 that is receivingly engageable with and thus mounted to the engagement slot of the stand 1. An anti-sliding seat 5 is arranged on the stand 1 for fixing the suspension bracket 3. Also referring to FIG. 6, the stand comprises at least one leg 6, which has an end forming a coupling block 61 that is receivingly engageable with the engagement slot 11 of the stand 1. The coupling block 61 is provided with a fastener element 63, which secures the leg 6 after the leg is put into engagement with the stand in order to improve stability to prevent the leg 6 from undesired movement and detachment. The leg 6 has an opposite end forming a caster 62.

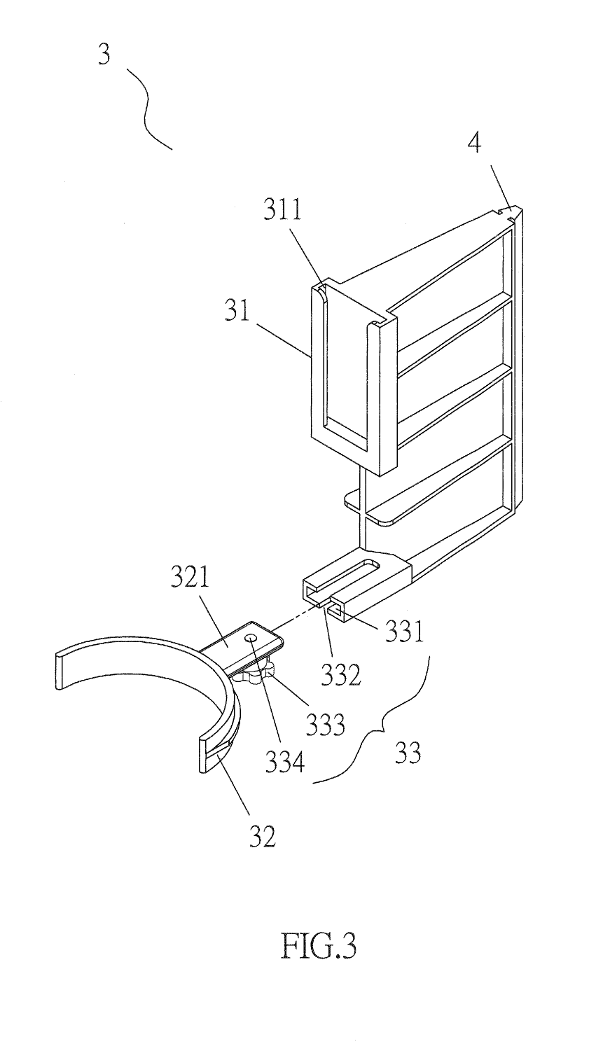

Referring to FIG. 3, which is an exploded view of the suspension bracket according to the present invention, the suspension bracket 3 of the present invention comprises a bottle seat 31, a carrying frame 32, and an adjustment section 33, which are coupled to each other sequentially. The carrying frame 32 forms a projection 321. The bottle seat 31 forms a seating slot 311 to receive and support a storage bottle suspending thereon. The adjustment section 33 comprises a guide channel 331, a guide slit 332, a locking element 333, and a fastening hole 334, which are coupled to each other sequentially. The fastening hole 334 is formed in the projection 321. The guide channel 331 receives the projection 321 to be fit therein. The locking element 333 extends through the guide slit 332 to engage the fastening hole 334 for selectively securing.

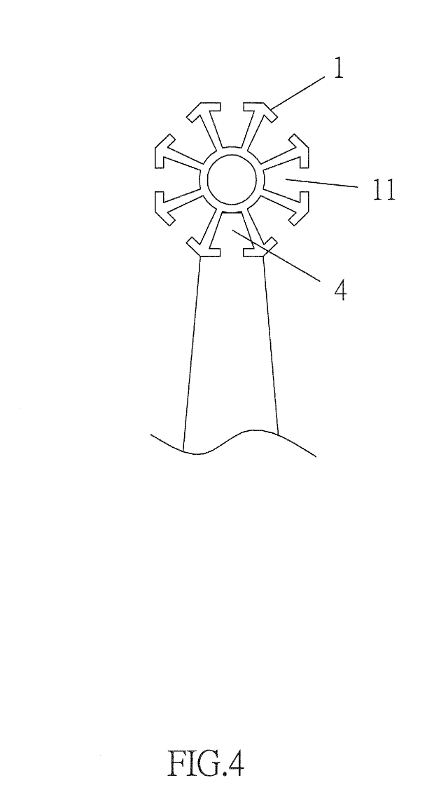

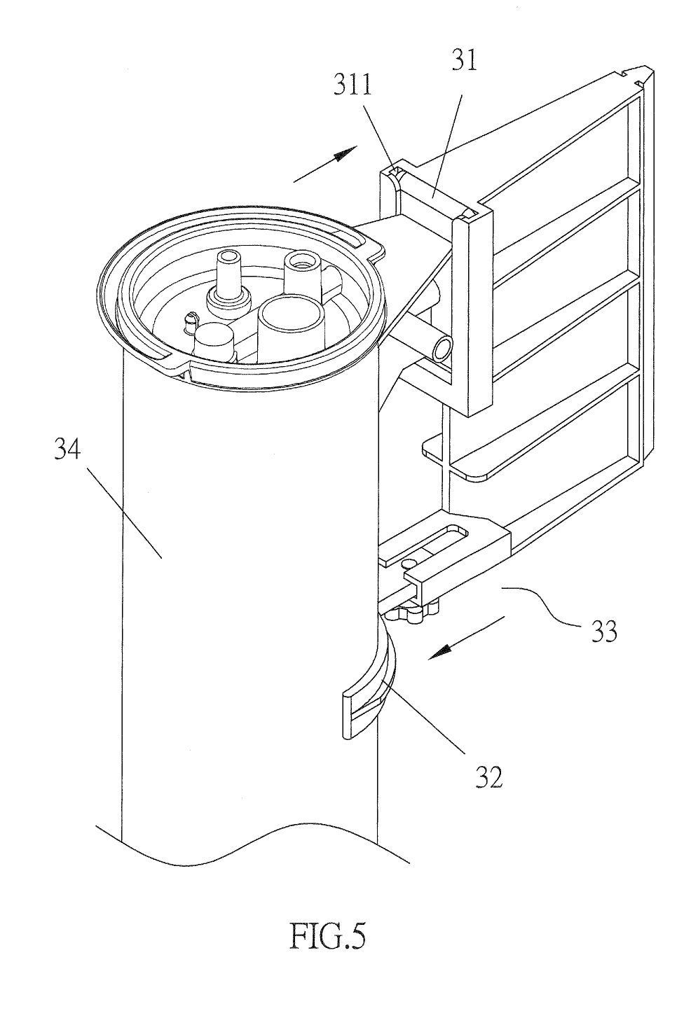

Referring to FIGS. 4 and 5, which are respectively a schematic view illustrating the mounting of the suspension bracket of the present invention and a perspective view illustrating the mounting of a storage bottle, the drawings show that the mounting block 4 of the suspension bracket is received in and engage the engagement slot 11 of the stand 1 for mounting. The bottle seat 31 forms a seating slot 311, which receives and supports a storage bottle 34 suspending thereon. The carrying frame 32 and the adjustment section 33 of the suspension bracket can be adjusted, according to the size of the storage bottle 34 suspended, to selectively move the carrying frame 32 forward or rearward in order to securely and stably hold and fix the storage bottle 34 to improve stability and eliminate potential risk of undesired oscillation.

Referring to FIG. 6, which is a perspective view illustrating the engagement and fixing of the leg according to the present invention, the drawing shows that the leg 6 has an end forming a coupling block 61, which is receivingly engageable with and thus fixed to the stand. Further, the coupling block 61 is further provided with a fastener element 63, which functions to secure the leg 6 after the leg 6 is set in engagement with the stand to improve the stability thereof to prevent the leg 6 from undesired movement and detachment.

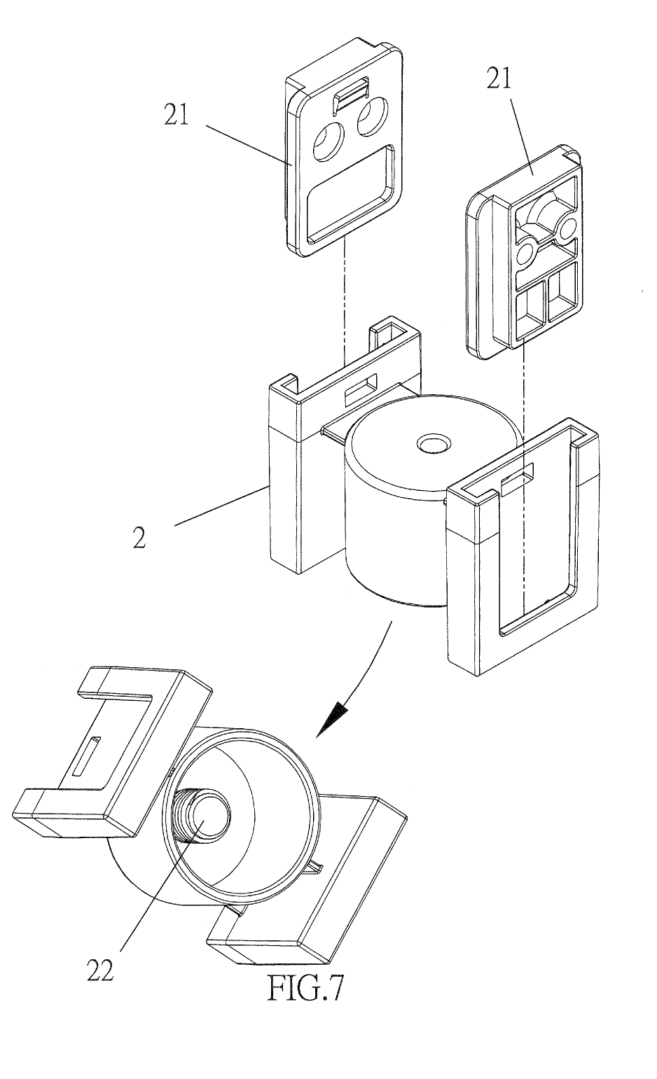

Referring to FIG. 7, which is an enlarged view of a portion of the present invention, the drawing shows that the top cap 2 forms at least one retention piece 21, which is mounted through receiving engagement to improve the stability thereof so as to prevent a gas valve mounted to the top cap 2 from undesired movement and detachment.

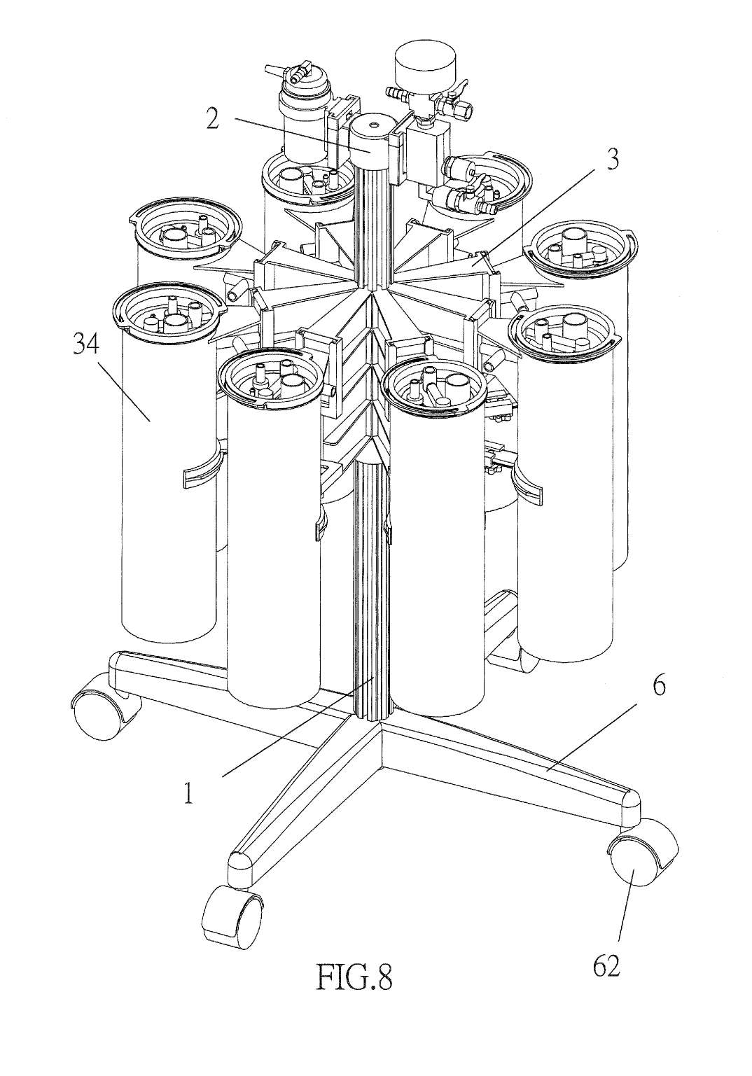

Finally, referring to FIG. 8, which is a perspective view illustrating an application of the present invention, the drawing shows that the present invention comprises the stand 1, which forms at least one engagement slot and has a top end to which a top cap 2 is mounted, the top cap 2 comprising an internally-arranged fastener element to securely fix to the stand 1; at least one the suspension bracket 3, which has an end forming a mounting block, which is engageable with and thus mounted to the stand 1, the suspension bracket 3 comprising a bottle seat, a carrying frame, and an adjustment section, the bottle seat forming a seating slot, which receives and supports a storage bottle 34 suspending thereon; the adjustment section comprising a guide channel, a guide slit, a locking element, and a fastening hole, the fastening hole being formed in the projection, the guide channel receiving the projection to fit therein, the locking element extending through the guide slit to engage the fastening hole for selectively securing; an anti-sliding seat, which is arranged on the stand 1 for fixing the suspension bracket 3; and at least one leg 6, which has an end forming a coupling block that is engageable with and thus fixed to the stand 1 and an opposite end forming a caster 62. The mounting block of suspension bracket is receivingly engageable with the engagement slot of the stand 1. The carrying frame and the adjustment section of the suspension bracket 3 support and hold the storage bottle 34 so as to improve the stability and prevent undesired oscillation.

The advantages of the present invention include at least:

(1) The present invention can be easily assembled and disassembled, is easy to store without occupying a large space.

(2) The adjustment element of the carrying frame of the present invention support and hold a storage bottle to improve stability and prevent undesired oscillation.

(3) The present invention uses a stand as a primary structure, which helps reducing manufacturing costs.

(4) The present invention uses a stand as a primary structure and incorporates a mounting block and a coupling block according to the structural arrangement of the stand to improve industrial use.

(5) The present invention uses a stand as a primary structure, which is of a structural arrangement that allows for hanging of a desired number of storage bottles that is greater than the number of storage bottles that a conventional vacuum suction bottle support rack can support.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. An adjustable vacuum suction bottle support rack, comprising:
a stand, which forms at least one engagement slot;
at least one suspension bracket, which has an end forming a mounting block receivingly engageable with the engagement slot of the stand;
an anti-sliding seat, which is arranged on the stand for fixing the suspension bracket; and
a leg, which has an end forming a coupling block receiving engageable with the engagement slot of the stand.

2. The adjustable vacuum suction bottle support rack according to claim 1, wherein the engagement slot is an open wedge-shaped slot, the mounting block and the coupling block being a wedge block.

3. The adjustable vacuum suction bottle support rack according to claim 1, wherein the suspension bracket comprises a bottle seat, a carrying frame, and an adjustment section, which are coupled to each other sequentially.

4. The adjustable vacuum suction bottle support rack according to claim 3, wherein the adjustment section comprises a guide channel, a guide slit, a locking element, and a fastening hole, which are coupled to each other sequentially.

5. The adjustable vacuum suction bottle support rack according to claim 1, wherein the stand comprises a top cap, the top cap comprising an internally arranged fastener element to fix to the stand.

6. The adjustable vacuum suction bottle support rack according to claim 5, wherein the top cap comprises at least one retention piece, which is receivingly engageable with the top cap.

7. The adjustable vacuum suction bottle support rack according to claim 1, wherein the leg has an opposite end forming a caster.

8. The adjustable vacuum suction bottle support rack according to claim 1, wherein the coupling block comprises at least one fastener element.
